(19) United States
(12) Patent Application Publication
(10) Pub. No.: US 2025/0326358 A1
(43) Pub. Date: Oct. 23, 2025

(54) HANGING VEHICLE-MOUNTED CAMERA DEVICE

(71) Applicant: Shenzhen Leqi Innovation Co., Ltd., Shenzhen (CN)

(72) Inventor: Wenming TANG, Zhongshan (CN)

(73) Assignee: Shenzhen Leqi Innovation Co., Ltd., Shenzhen (CN)

(21) Appl. No.: 19/251,876

(22) Filed: Jun. 27, 2025

Related U.S. Application Data
(63) Continuation of application No. PCT/CN2023/115903, filed on Aug. 30, 2023.

(30) Foreign Application Priority Data
Dec. 29, 2022 (CN) 202211742246.7

(51) Int. Cl. B60R 11/04; B60R 11/00

(52) U.S. Cl. CPC B60R 11/04; B60R 2011/004; B60R 2011/0059; B60R 2011/0068; B60R 2011/0084; B60R 2011/0087

(57) ABSTRACT

A hanging vehicle-mounted camera device, comprises: a support structure, including two hanging units and an installation crossbar; and an installation structure, including an installation frame for mounting a camera. The two hanging units are spaced apart in a transverse direction, each hanging unit comprising a hanging rod and two support rods installed at upper and lower ends of the hanging rod, the hanging rod extends in a vertical direction, the two support rods extend in a longitudinal direction, the upper support rod is adapted to cooperate with a deflector groove on an upper side of a vehicle door, the lower support rod is adapted to cooperate with an outer surface of the vehicle door, and a sliding seat is mounted on the installation crossbar for sliding movement in the transverse direction; and one end of the installation frame in the longitudinal direction is detachably mounted on the sliding seat.

### CROSS-REFERENCE TO RELATED APPLICATIONS

The present application is a continuation application of PCT/CN2023/115903 filed on Aug. 30, 2023, which claims the priority of Chinese Patent Application No. 202211742246.7 filed on Dec. 29, 2022, the entire contents of which are incorporated herein by reference.

### TECHNICAL FIELD

The present invention relates to the technical field of photography equipment, and more particularly to a hanging vehicle-mounted camera device.

### BACKGROUND

During the development of vehicle-mounted camera devices, to achieve a hands-free camera support method for photographers, existing structures mainly focus on the side doors of vehicles. These typically require lowering the vehicle window and using a bullhead mount for installation. However, this approach prevents the window from being closed during use. Users may lack confidence in suction-based installation methods, which can be unreliable in extreme weather conditions, potentially hardening and failing to adhere. Moreover, suction cups can wobble during use, causing unstable footage. There's also a risk of camera drop due to air leakage, and their limited load capacity may deter users from mounting heavier equipment. Additionally, varying vehicle door designs can lead to tilted bullhead mounts, resulting in a tilted camera. Current devices often fix the camera in a single position. In the confined space of a vehicle, it is difficult for users to reposition the camera to shoot subjects on both sides of the door.

Existing vehicle-mounted camera devices place the equipment on the vehicle window, fixing the shooting position at the window's height. This setup forces users into a top-down shooting angle, especially when photographing wildlife, leading to poor shooting perspectives and effects.

Video recording has become a trend, and video shooting requires high stability. Even slight shaking can ruin a video. Any movement inside the vehicle can cause it to wobble, and existing devices, which place equipment on the window, fail to meet video shooting's stability demands.

Thus, the development of external vehicle camera mounts needs continuous improvement.

### SUMMARY

The main objective of the present application is to present a hanging vehicle-mounted camera device. It is positioned overall on the outer side of the vehicle door through a deflector groove and the outer surface of the vehicle door, featuring robust load capacity and stability. It operates independently of the vehicle window and allows it to be closed, enhancing safety. The camera installation offers adjustable positions in both horizontal and vertical directions, providing flexibility. Users can slightly turn their bodies to capture subjects on both sides of the vehicle door.

To achieve the aforementioned objective, the present invention provides a hanging vehicle-mounted camera device, comprising:
a support structure, including two hanging units and an installation crossbar, wherein the two hanging units are spaced apart in a transverse direction, each hanging unit comprising a hanging rod and two support rods detachably installed at upper and lower ends of the hanging rod, the hanging rod extends in a vertical direction with an adjustable length, the two support rods extend in a longitudinal direction, the upper support rod is adapted to cooperate with a deflector groove on an upper side of a vehicle door, the lower support rod is adapted to cooperate with an outer surface of the vehicle door, the installation crossbar is located on the side of the two hanging units facing the vehicle door, and a sliding seat is mounted on the installation crossbar for sliding movement in the transverse direction; and
an installation structure, including an installation frame for mounting a camera, one end of the installation frame in the longitudinal direction is detachably mounted on the sliding seat.

In one embodiment, further comprising a connecting hanger, the upper end of which is bent to define a hanging slot, wherein the hanging slot can cooperate with the outer surface of the sliding seat, and the connecting hanger is fixed to the sliding seat with a screw;
and the installation frame can be connected to a side face of the connecting hanger.

In one embodiment, a first leveling assembly is provided between the installation frame and the connecting hanger, so as to allow the installation frame to rotate relative to the connecting hanger for horizontal adjustment in the transverse direction.

In one embodiment, the first leveling assembly comprises:
a seat body, fixedly mounted on the side of the installation frame facing the connecting hanger;
a connecting sleeve, fixedly mounted on the corresponding side face of the connecting hanger, and fitted over the outer surface of the seat body;
a bearing, an inner ring thereof is fitted over an outer surface of the seat body, and an outer ring thereof is fixedly mounted in an inner hole of the connecting sleeve, thereby enabling relative rotation between the seat body and the connecting sleeve; and
a locking structure, keeping the seat body and the connecting sleeve fixed.

In one embodiment, a second leveling assembly is provided between the seat body and the installation frame, and the second leveling assembly comprises:
a base plate, fixedly mounted on the side of the seat body opposite to the connecting hanger; and
a wedge-shaped adjusting block, mounted on the base plate for movement in the vertical direction and has an abutting inclined surface extending from top to bottom towards the installation frame;
wherein one end of the installation frame facing the connecting hanger is pivotally mounted on the base plate around a transverse axis, so that the other end of the installation frame can swing in the vertical direction, and the abutting inclined surface always abuts against a front lower side of the installation frame during the movement of the adjusting block, thereby adjusting an included angle between the installation frame and the base plate.

In one embodiment, the installation structure comprises a sliding seat structure, which is slidably mounted on the installation frame in the longitudinal direction and is used for installing a camera.

In one embodiment, the installation structure further comprises a lifting assembly, which comprises:
a first movable seat, slidably mounted on the installation frame in the longitudinal direction and spaced apart from the sliding seat structure in the longitudinal direction;
a telescopic rod, extending in the vertical direction, comprising a first tube and a second tube fitted over each other, the first tube and the second tube being movable relative to each other, the upper end of the second tube being connected to the first movable seat, and the lower end of the first tube being insertable into the ground;
a hand-cranked reeling mechanism, comprising a hand-cranked reel and a connecting wire, one end of the connecting wire being connected to the first tube, and the other end being fixed on the hand-cranked reel, so as to lift the first tube when the connecting wire is reeled in; and
a locking member, locking the first tube and the second tube in a fixed position.

In one embodiment, comprising a length-adjustable installation rod, an upper end of the installation rod being used for installing a camera, and a lower end of the installation rod being insertable into the ground, the installation rod being installed via the sliding seat structure, which comprises:
two movable blocks, spaced apart in the transverse direction and slidably mounted on the installation frame;
a base plate, detachably mounted on the two movable blocks, the base plate having a central through-hole; and
a fixing seat, provided on the base plate, the fixing seat having a through passage extending vertically and communicating with the through-hole, for the installation rod to pass through, the fixing seat having an unlocked state in which the installation rod can slide vertically and a locked state in which it is fixed relative to the installation rod.

In one embodiment, an included angle between the installation crossbar and the plane formed by the two hanging rods is adjustable.

In one embodiment, comprising a supporting assembly, which comprises a plurality of supporting sections, upper ends of the supporting sections being spaced apart around the installation rod on the fixing seat, and lower ends of the supporting sections being insertable into the ground.

In one embodiment, the two movable blocks each define an upward-through accommodation groove on opposing side surfaces, a lower wall of each accommodation groove having two first slots spaced longitudinally apart, walls of the two first slots facing away from each other are configured to pass through the corresponding movable block;
the base plate has two transversely opposing mounting ends, each inserted into the respective accommodation groove, and the base plate can be inclined relative to the movable blocks under external force, so that each mounting end can extend into the corresponding first slot, and the base plate is used for installing the installation rod mounted with a camera.

In one embodiment, the upper support rod cooperates with the deflector groove on an upper side of the vehicle door via a first connecting unit, each first connecting unit including a clip and a bolted rod, an upper end of the clip is bent away from the hanging rod to form a downward-opening clip groove for engagement with the deflector groove, one end of the bolted rod is connected to a longitudinal side of the clip, and the other end is threadedly mounted to the corresponding support rod.

In one embodiment, the upper support rod cooperates with the deflector groove on an upper side of the vehicle door via a first connecting unit, each first connecting unit including a abutting member and at least one strap structure, the abutting member contacts the vehicle door surface, the strap is fixed to the vehicle door frame, and the abutting member is pressed against the vehicle door.

In one embodiment, the lower support rod cooperates with a surface of the vehicle door via a second connecting unit, each second connecting unit including a suction cup connected to the corresponding support rod via a hinge.

In one embodiment, comprising two clamping structures corresponding to the two hanging units, each clamping structure includes a bracket, a self-locking sleeve, and a hinge, wherein an upper surface of the bracket defines a first installation slot running through transversely for fixing the installation crossbar, the self-locking sleeve accommodates the hanging rod, the hinge connects the bracket and the self-locking sleeve, and the bracket is fixed to the installation crossbar either by a clamping fixture or via a hinge structure combined with a safety catch.

To achieve the aforementioned objective, the present invention provides a hanging vehicle-mounted camera device, comprising:
a support structure, including two hanging units and an installation crossbar;
an installation structure, including an installation frame for mounting a camera; and
two clamping structures, corresponding to the two hanging units;
wherein the two hanging units are spaced apart in a transverse direction, each hanging unit is height-adjustable in a vertical direction; an upper end and a lower end of each hanging unit are respectively configured to cooperate with a deflector groove and an outer surface of a vehicle door; the installation crossbar is located between the two hanging units in the transverse direction, the two hanging units are connected to opposite ends of installation crossbar by the two clamping structures; the installation frame is slidably mounted on the installation crossbar in the transverse direction, and a position of the camera on the installation frame is adjustable in a longitudinal direction.

In one embodiment, each hanging unit comprises a hanging rod and two support rods, the hanging rod extends in the vertical direction with an adjustable length; the two support rods extend in the longitudinal direction, and are respectively installed at upper and lower ends of the hanging rod.

In one embodiment, each of the upper support rods is coupled with the deflector groove of the vehicle door via a first connection unit;
each of the first connection units includes a clip and a bolted rod, the clip is bent to form a downward-facing clip groove, which is used for snap-fit engagement with the deflector groove;
one end of the bolted rod connects the clip, and the other end is threadedly installed to the corresponding support rod.
19. The hanging vehicle-mounted camera device according to claim 16, wherein each of the lower support rods interfaces with the outer surface of the vehicle door via a second connecting units, and each second connecting unit includes a suction cup 141, which is used for adhesively fixing to the outer surface.

In one embodiment, the installation structure comprises:
a sliding seat structure, slidably mounted on the installation frame in the longitudinal direction and used for installing a camera; and
a lifting assembly, comprising:
a first movable seat, slidably mounted on the installation frame in the longitudinal direction;
a telescopic rod, extending in the vertical direction, comprising a first tube and a second tube fitted over each other, the first tube and the second tube being movable relative to each other, the upper end of the second tube being connected to the first movable seat, and the lower end of the first tube being insertable into the ground;
a hand-cranked reeling mechanism, including a hand-cranked reel and a connecting wire, one end of the connecting wire being connected to the first tube, and the other end being fixed on the hand-cranked reel, so as to lift the first tube when the connecting wire is reeled in; and
a locking member, locking the first tube and the second tube in a fixed position.

In the present application, the deflector groove of the vehicle door is the welding point, which generally has a certain depth and is the most solid position of the door panel. The upper end of each hanging rod is fitted with the deflector groove, and the lower end is fitted with the outer surface, which has a high connection strength with the vehicle door. The cooperation of the two hanging structures can provide good load-bearing capacity and stability. The camera can be installed on the sliding seat structure, and the transverse and vertical adjustment can be realized under the driving of the sliding seat and the sliding seat structure, which has good flexibility. By rotating the camera and slightly turning the body, the user can shoot the subjects on both sides of the vehicle door. At the same time, the length of the hanging rod can be adjusted to adapt to the door height of different models, with good versatility. There is no direct cooperation relationship with the vehicle window, which does not affect the closing of the window during driving, and the safety performance is better.

### BRIEF DESCRIPTION OF THE DRAWINGS

To more clearly illustrate the technical solutions in the embodiments of the present application or in the prior art, the following is a brief introduction to the drawings used in the descriptions of the embodiments and the prior art. It should be evident that the drawings described below are only some embodiments of the present application. A person of ordinary skill in the field can obtain other drawings based on these drawings without expending creative effort.

FIG. 1 is a stereoscopic diagram of a hanging vehicle-mounted camera device according to a first embodiment of the present application;

FIG. 2 is a stereoscopic diagram showing the cooperation between a lifting assembly and an installation frame in FIG. 1;

FIG. 3 is a stereoscopic diagram of a clamping structure in FIG. 1;

FIG. 4 is a stereoscopic diagram of a fixed connection seat in FIG. 3;

FIG. 5 is a stereoscopic diagram of a height adjustment block in FIG. 3;

FIG. 6 is a stereoscopic diagram of a hanging vehicle-mounted camera device according to a second embodiment of the present application;

FIG. 7 is a stereoscopic diagram showing the cooperation between a sliding seat structure and the installation frame in FIG. 6;

FIG. 8 is a stereoscopic diagram of the sliding seat structure according to one embodiment in FIG. 6;

FIG. 9 is a stereoscopic diagram of a platform in FIG. 8;

FIG. 10 is a stereoscopic diagram of a movable block in FIG. 8;

FIG. 11 is a stereoscopic diagram of an insert block body in FIG. 8;

FIG. 12 is a stereoscopic diagram of a locking block in FIG. 8;

FIG. 13 is a stereoscopic diagram of the sliding seat structure according to another embodiment in FIG. 6;

FIG. 14 is a stereoscopic diagram of a first leveling assembly in FIG. 6;

FIG. 15 is a stereoscopic diagram of a second leveling assembly in FIG. 6;

FIG. 16 is a stereoscopic diagram of a hanging vehicle-mounted camera device according to a third embodiment of the present application;

FIG. 17 is a stereoscopic diagram of a first connecting unit of the hanging vehicle-mounted camera device provided by the present application;

FIG. 18 is a stereoscopic diagram of a hanging vehicle-mounted camera device according to a fourth embodiment of the present application; and

FIG. 19 is a partial stereoscopic diagram of a hanging vehicle-mounted camera device according to a fifth embodiment of the present application.

### DESCRIPTION OF THE EMBODIMENTS

The technical solutions in the embodiments of the present application will be described clearly and comprehensively below with reference to the accompanying drawings in the embodiments of the present application. It is evident that the described embodiments represent only a portion of the embodiments of the present application, rather than all embodiments. Based on the embodiments in the present application, all other embodiments obtained by a person of ordinary skill in the art without creative efforts shall fall within the scope of protection of the present application.

It should be noted that if directional indications (e.g., up/down, left/right, front/rear) are involved in the embodiments of the present application, such indications are used solely to explain relative positional relationships, movement conditions, etc., between components in a specific posture. If the specific posture changes, the directional indication will change accordingly.

Furthermore, if descriptions such as “first,” “second,” etc., appear in the embodiments of the present application, these terms are for descriptive purposes only and should not be construed as implying relative importance or implicitly indicating the quantity of the specified technical features. Thus, features defined by “first” or “second” may explicitly or implicitly include at least one such feature. Technical solutions across different embodiments may be combined; however, such combinations must be achievable by a person of ordinary skill in the art. If a combination of technical solutions results in contradictions or impossibility of implementation, such combination shall be deemed non-existent and outside the scope of protection claimed by the present application.

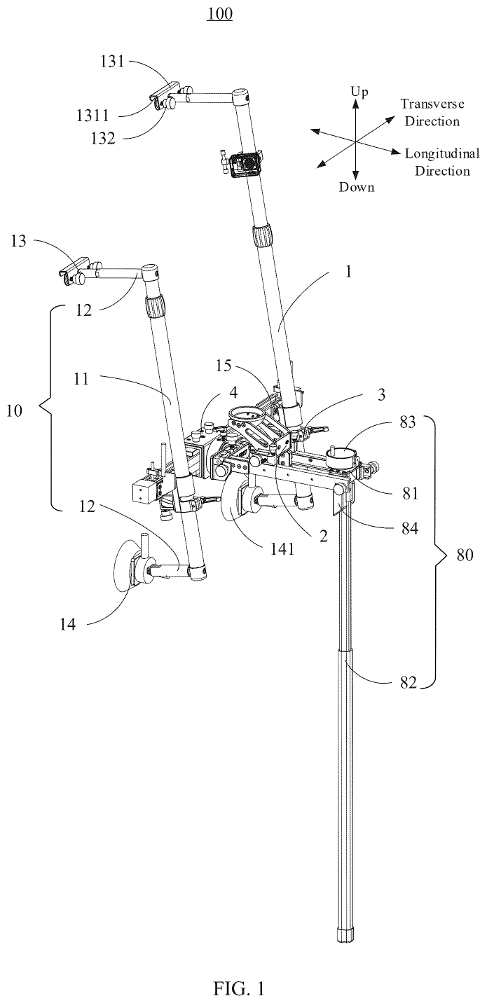

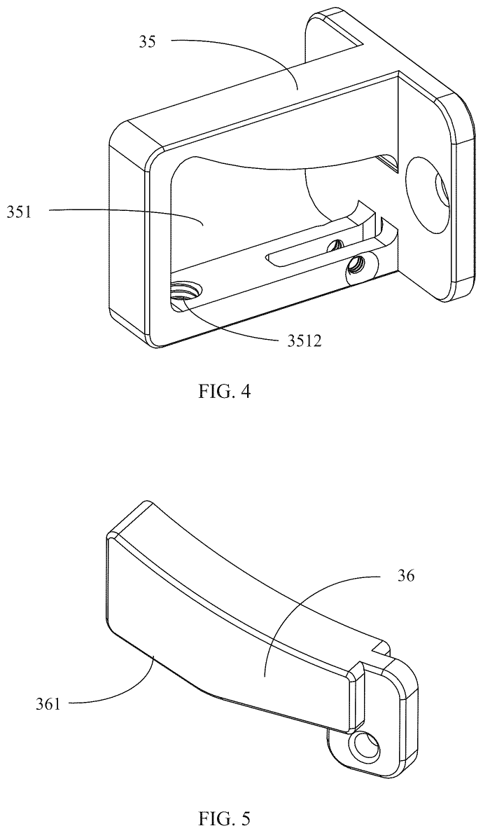

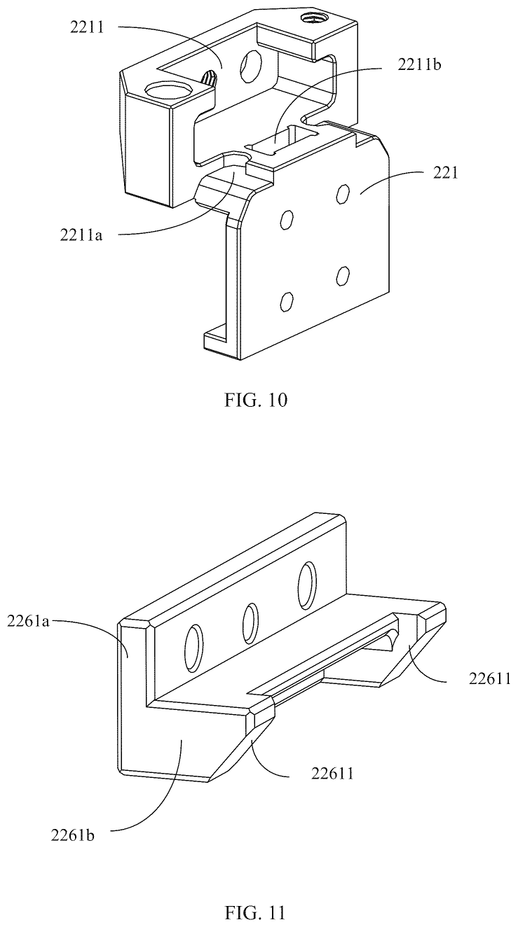

The present application provides a hanging vehicle-mounted camera device. It is hung on an outer side of a vehicle door via a deflector groove and an outer surface of a vehicle door. It has a high load-bearing capacity and stability, no cooperation with the vehicle window, allows the window to be closed, offers better safety, and enables horizontal and vertical camera position adjustments for flexibility. Users can capture subjects on both sides of the vehicle door with a slight body turn. FIGS. 1 to 19 illustrate various embodiments of hanging vehicle-mounted camera device according to the present application.

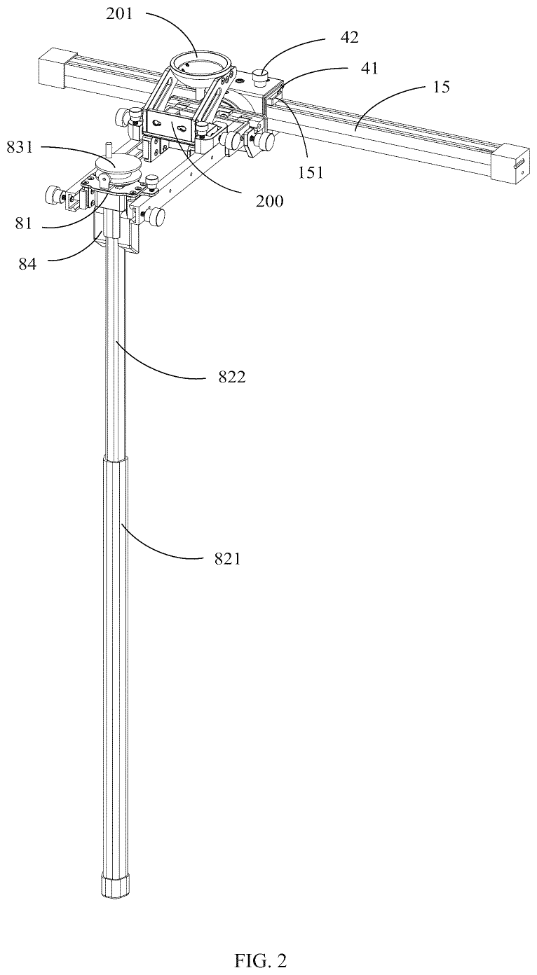

As shown in FIGS. 1 and 2, the hanging vehicle-mounted camera device 100 includes a support structure 1 and an installation structure 2. The support structure 1 comprises two hanging units 10 and an installation crossbar 15, the two hanging units 10 being spaced apart in a transverse direction. Each hanging unit 10 includes a hanging rod 11 and two support rods 12. The hanging rod 11 extends vertically and has an adjustable length. The two support rods 12 extend in a longitudinal direction, the upper support rod 12 engages with the deflector groove on the upper part of the vehicle door, while the lower support rod 12 contacts the outer surface of the vehicle door. The installation crossbar 15 is located on the side of the two hanging units 10 facing the vehicle door. The installation crossbar 15 has a sliding seat 151 that can slide transversely. The installation structure 2 comprises an installation frame 21 and a sliding seat structure 22. The sliding seat structure 22 is mounted on the installation frame 21 for longitudinal sliding and is used for camera installation. One end of the installation frame 21 in a longitudinal direction is detachably mounted on the sliding seat 151.

In the technical solution of the present application, the deflector groove of the vehicle door is the welding point of the vehicle door, generally having a certain depth, and is the strongest position of the door panel. The upper end of each of the hanging rods 11 is fitted with the deflector groove, and the lower end is fitted with the outer surface of the door, which has a high connection strength with the door. The cooperation of the two hanging units 10 can provide good bearing capacity and stability. A camera can be installed on the sliding seat structure 22, and the transverse and longitudinal direction adjustment can be realized under the driving of the sliding seat 151 and the sliding seat structure 22, providing good flexibility. By rotating the shooting direction of the camera and slightly turning the user's body, the subject on both sides of the vehicle door can be photographed. The length of the hanging rod 11 can be adjusted to adapt to the door height of different models, with good versatility. There is no direct cooperation relationship with the vehicle window, which does not affect the closing of the vehicle window during driving, and the safety performance is better.

The present application does not limit the specific manner in which the sliding seat 151 and the installation crossbar 15 are slidably fitted. In one embodiment, a slider and a slide rail can be used for fitting. In this embodiment, referring to FIG. 2 and FIG. 7, the installation crossbar 15 is provided with transversely extending sliding grooves 152 on the upper and lower opposite side surfaces. The sliding seat 151 is configured in a cylindrical shape and can be sleeved on the outside of the installation crossbar 15. An inner hole of the sliding seat 151 has pulley guide rails corresponding to the upper and lower wall surfaces. The pulleys of each pulley guide rail are slidably installed into the corresponding slide grooves. This ensures that the sliding seat 151 experiences less friction and slides more smoothly when sliding on the installation crossbar 15. Furthermore, due to the cylindrical configuration of the sliding seat 151, it has a relatively uniform fitting gap with the peripheral side of the installation crossbar 15, making it less prone to slippage.

It is understandable that installation crossbar 15 can be obtained by machining sliding grooves 152, or it can be a profile with sliding grooves 152. It is understandable that the through sliding grooves 152 are for easy installation, and a plug needs to be set at the end position of the installation crossbar 15.

To ensure a tight fit between the hanging units 10 and the deflector groove on the upper part of the vehicle door, in one embodiment, in each of the hanging units 10, the upper support rod 12 is coupled with the upper deflector groove of the vehicle door via first connection units 13. Each of the first connection units 13 includes a clip 131 and a bolted rod 132. The upper end of the clip 131 is bent in the direction away from the hanging rod 11 to form a downward-facing clip groove 1311. The clip groove 1311 is used for snap-fit engagement with the upper deflector groove of the vehicle door. One end of the bolted rod 132 connects the clip 131 on its longitudinal side, and the other end is threadedly installed to the corresponding support rod 12. That is, the clip 131 is designed with a bent shape to present an overall hook-type design, which can be directly buckled into the deflector groove to form a hanging connection. The design of the bolted rod 132 is for the overall detachable and replaceable design of the first connection unit 13. In other embodiments, a clamping fit can also be designed, or the fit can be achieved by pressing and installing inside the deflector groove through elastic members, which is not limited here. It can be understood that the initial angle of the clip 131 can be adjusted by the threaded connecting rod 2272.

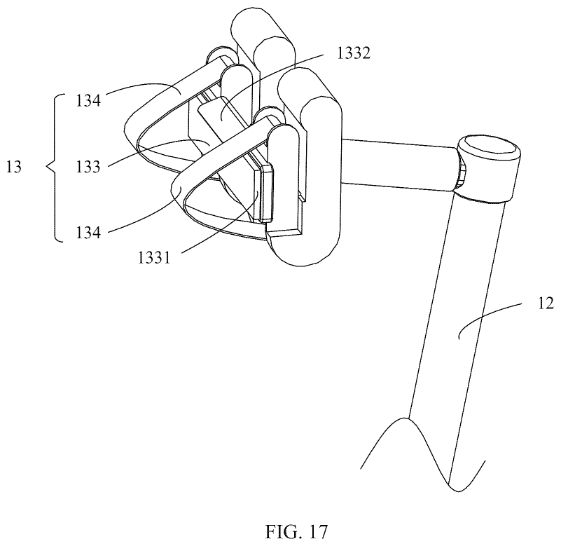

The present application does not limit the specific structural form of the first connection units 13. In another embodiment, each of the first connection units 13 includes an abutting member 133 and at least one strap structure 134. The abutting member 133 is used to contact the outer surface of the vehicle door, and a strap of the strap structure 134 can be fixed on a frame of the vehicle door and can make the abutting member 133 adhere to the vehicle door. Referring to FIG. 17, in one embodiment, the abutting member 133 is plate-shaped, and a cushion 1331 can be added to prevent scratching the vehicle door. Two strap structures 134 are provided, and the length of the strap exposed by each strap structure 134 can be adjusted. The strap structure 134 can be a buckle-type self-locking strap that can be purchased, or it can be designed independently, without limiting. An inclined insert plate 1332 can be added to the abutting member 133 for positioning.

Furthermore, considering that there is a certain fitting gap in the hanging fit, vibration and abnormal noise may occur when the vehicle is running, which will cause vibration to the camera and affect its shooting stability. Therefore, in this embodiment, each of the first connecting units 13 further includes two abutting pieces respectively arranged on the transverse sides of the bolted rod 132. Each abutting piece includes a bolt and an annular top plate. The bolt is threadedly installed to the lower end of the clip 131 and can pass through the clip 131. An inner hole of the annular top plate is sleeved on the end of the bolt protruding from the clip 131, and the end face of the annular top plate is used to abut against the outside of the deflector groove. In use, the clip 131 is first hung on the corresponding position of the deflector groove. At this time, the bolt is loosened as a whole. After installation, the bolt is tightened so that the annular top plate can abut against the outside of the vehicle door, thereby limiting and locking it, ensuring a good fitting relationship and improving the stability of assembly.

It is understandable that the entire annular top plate may be flared, similar to the function of a gasket, which can increase the mating area. Meanwhile, the fitting area between the annular top plate and the vehicle door may be coated with rubber.

To ensure a secure fit between the hanging units 10 and the outer surface of the vehicle door, in one embodiment, each of the hanging units 10 includes a lower support rod 12 that interfaces with the outer surface of the vehicle door via second connecting units 14. Each second connecting unit 14 includes a suction cup 141, which is used to adhere and fix to the outer surface of the vehicle door. A base of the suction cup 141 is rotatably mounted to the corresponding support rod 12 along a transversely extending axis. The suction cup adhesion method ensures good load-bearing capacity, while the suction cup 141 can adapt to the curved surface of the vehicle door, ensuring secure fastening. By reasonably adjusting the angle of the suction cup 141 relative to the support rod 12, it can be adapted to the overall shape of the vehicle door. This design is simple and easy to install.

The suction cup 141 is connected to the corresponding support rod 12 via a hinge structure with a transversely extending pin, allowing relative movement between the suction cup 141 and the support rod 12.

Furthermore, the hanging vehicle-mounted camera device 100 includes a connecting hanger 4. The upper end of the connecting hanger 4 is bent to form a downward-opening hanging slot 41, which cooperates with the outer surface of the sliding seat 151. The connecting hanger 4 is fixed to the sliding seat 151 with a screw 42, and the installation frame 21 can be connected to the side face of the connecting hanger 4. The connecting hanger 4 is generally U-shaped, with the two side walls of the U-shaped structure having different lengths to provide sufficient installation space for the installation frame 21. In one embodiment, the shape of the hanging slot 41 matches the outer shape of the sliding seat 151 to ensure a proper fit and prevent wobbling.

It is understandable that, in this embodiment, the installation frame 21 includes a support plate and two installation beams 211 arranged on both transverse sides of the support plate and extending longitudinally. The two installation beams 211 are provided for the slidable mounting of the sliding seat structure 22, and the support plate is connected to the installation crossbar 15. The overall mass is relatively light, facilitating the installation and threading of parts.

Furthermore, a first leveling assembly 6 is arranged between the installation frame 21 and the connecting hanger 4, the first leveling assembly 6 being used to enable the installation frame 21 to rotate relative to the connecting hanger 4 for transverse leveling adjustment. The installation frame 21 as a whole is able to rotate about a longitudinally extending axis to achieve horizontal adjustment.

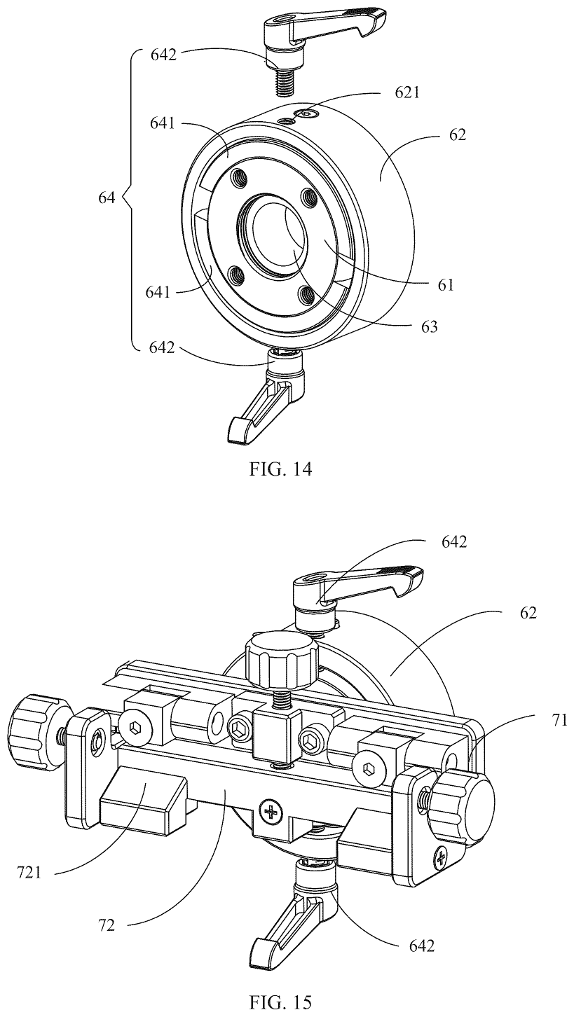

The present application does not limit the structural form of the first leveling assembly 6. In one embodiment, referring to FIG. 7 and FIG. 14, the first leveling assembly 6 includes a seat body 61, a connecting sleeve 62, a bearing 63, and a locking structure 64. The seat body 61 is fixedly installed on the side of the installation frame 21 facing the connecting hanger 4. The connecting sleeve 62 is fixedly installed on the corresponding side of the connecting hanger 4. The connecting sleeve 62 is sleeved on the outer surface of the seat body 61. An inner ring of the bearing 63 is sleeved on the outer surface of the seat body 61, and an outer ring of the bearing 13 is fixed to an inner hole of the connecting sleeve 62, so that the seat body 61 and the connecting sleeve 62 can rotate relative to each other. The locking structure 64 is used to keep the seat body 61 and the connecting sleeve 62 fixed. Due to the structural characteristics of the bearing 63, the connecting sleeve 62 and the seat body 61 can rotate relative to each other. That is, when the sliding seat 151 is fixed, the installation frame 21 can rely on this structure to rotate relatively. After rotating to the required angle, the installation frame 21 is fixed by the locking structure 64, thereby completing the maintenance of the horizontal state.

The locking structure 64 can be arranged on the outside of the connecting sleeve 62, for example, by inserting a tab into a gap between the connecting sleeve 62 and the seat body 61 after leveling, thereby locking the bearing 63 and completing the fixation. However, the tab needs to be vehicleried and stored. In this embodiment, referring to FIG. 14 to FIG. 15, two threaded holes 621 are defined on opposite sides of the connecting sleeve 62. The locking structure 64 includes two clamping sections 641 and two hand-tightening bolts 642. The two clamping sections 641 are arranged opposite to each other along the circumference of the seat body 61 and are both located between the seat body 61 and the connecting sleeve 62. The two clamping sections 641 are spaced apart from the bearing 63 in the longitudinal direction. Two grooves are provided on the sides of the two clamping sections 641 facing away from each other, corresponding to the two threaded holes 621. The two hand-tightening bolts 642 respectively pass through the two threaded holes 621 and extend into the two grooves. Tightening the two hand-tightening bolts 642 causes the two clamping sections 641 to abut against the seat body 61, so that the seat body 61 and the connecting sleeve 62 remain fixed. Loosening the hand-tightening bolts 642 allows the clamping section 641 to wobble within the gap. At this time, the seat body 61 is no longer constrained and can therefore rotate again. Throughout the process, the lower hand-tightening bolt 642 can remain in a pre-tightened state, which provides a certain amount of friction to the rotation of the seat body 61, thereby controlling its rotational speed. When locking is required, only the upper hand-tightening bolt 642 needs to be operated to achieve both clamping sections 641 closely contacting the seat body 61, thereby mechanically locking the seat body 61 for easing user's operation. The shape of the clamping section 641 is arc-shaped, so as to match the shape of the seat body 61 and the connecting sleeve 62. The clamping section 641 is made of a rigid material.

It should be noted that each of the hand-tightened bolts 642 is always in a state of being inserted into the groove, and even if the hand-tightened bolts 642 are loosened, the clamping section 641 will not rotate together with the seat body 61.

In other embodiments, the first leveling assembly 6 can be actively driven to rotate the installation frame 21 through motor gear transmission, or it can be rotated by user's operation through ball hinges, planetary gear transmission, shaft cooperation, and other methods as in this embodiment, which will not be described in detail here.

Furthermore, referring to FIG. 15, a second leveling assembly 7 is provided between the seat body 61 and the installation frame 21. The second leveling assembly 7 includes a base plate 71 and a wedge-shaped adjusting block 72. The base plate 71 is fixedly installed to the side of the seat body 61 away from the connecting hanger 4. The wedge-shaped adjusting block 72 is movably installed to the base plate 71 in a vertical direction. The wedge-shaped adjusting block 72 has an abutting inclined surface 721 extending from top to bottom toward the installation frame 21. One end of the installation frame 21 facing the connecting hanger 4 is pivotally mounted on the base plate 71 along around a transverse axis, so that the other end of the installation frame 21 can swing up and down in the vertical direction. The abutting inclined surface 721 always abuts against a front lower side of the installation frame 21 during the movement of the adjusting block 72, so as to adjust an included angle between the installation frame 21 and the base plate 71. That is, in the process of use, a horizontal adjustment of the installation frame 21 in the transverse direction can be achieved first through the first leveling assembly 6, and then a horizontal adjustment of the installation frame 21 in the longitudinal direction can be achieved through the second leveling assembly 7. Specifically, the wedge-shaped adjusting block 72 is driven to move up and down according to the actual inclination angle of the installation frame 21. Due to the setting of the abutting inclined surface 721, it not only plays the role of supporting the installation frame 21, but also during the movement of the wedge-shaped adjusting block 72, a contact position between the installation frame 21 and the abutting inclined surface 721 will change with a height change of the wedge-shaped adjusting block 72, so as to realize the angle adjustment of the installation frame 21, realize the horizontal adjustment for ensuring that the installation frame 21 is always parallel to the ground, and ensure the vertical alignment and smooth pivoting operation of an installation rod 9 for installing a camera. It solves the problem that the existing vehicle-mounted camera is tilted to the ground with the curved contour of the vehicle door after installation.

It can be understood that the contact position between the installation frame 21 and the abutting inclined surface 721 is on one side of the installation frame 21. For example, initially, the side of the installation frame 21 corresponds to a contact position A on the abutting inclined surface 721; when the wedge-shaped adjusting block 72 is adjusted so that the side of the installation frame 21 is in contact with a contact position B above the contact position A, in the transition from the contact position A to the contact position B, the wedge-shaped adjusting block 72 falls, and the installation frame 21 swings downward.

The present application does not limit the manner in which the wedge-shaped adjusting block 72 achieves lifting and lowering. It can be achieved by providing a lead screw structure on the base plate 71 to be drivingly connected to the wedge-shaped adjusting block 72. However, considering the overall volume and aesthetics of the device, a threaded driving method is adopted in this embodiment.

When a camera is installed on the sliding seat structure 22, considering that the installation frame 21 as a whole has a long shape, the installation frame 21 may experience uneven force distribution, due to one end being connected and the other end being cantilevered. It potentially affects stability and support strength. Therefore, in one embodiment, referring to FIG. 2, the installation structure 2 also includes a lifting assembly 80. The lifting assembly 80 includes a first movable seat 81, a telescopic rod 82, a hand-cranked reeling mechanism 83, and a locking member 84. The first movable seat 81 is slidably installed on the installation frame 21 in the longitudinal direction and is longitudinally spaced from the sliding seat structure 22. The telescopic rod 82 extends in the vertical direction. The telescopic rod 82 includes a first tube 821 and a second tube 822 that are sequentially sleeved. The first tube 821 and the second tube 822 are relatively movable. The upper end of the second tube 822 is connected to the first movable seat 81, and the lower end of the first tube 821 is used for insertion into the ground. The hand-cranked reeling mechanism 83 includes a hand-cranked reel 831 and a connecting wire (not shown). The end of the connecting wire is connected to the first tube 821, and the other end is fixed on the hand-cranked reel 831, so that the first tube 821 can be lifted up during winding. The locking member 84 can lock and fix the first tube 821 and the second tube 822. It can be understood that an overall selling rod structure having a telescopic rod 82 and a locking member 84 can be obtained through purchase. The locking member 84 is manual, and the user can quickly detach the first tube 821 and the second tube 822 by releasing the locking member 84. Considering that the user may be inside the vehicle, difficulties may be encountered in the recovery process of the first tube 821. Through this structure, the user can manually rotate the hand-cranked reel 831 to pull the first tube 821 back into the second tube 822 through the connecting wire, facilitating easy storage and continued vehicle use.

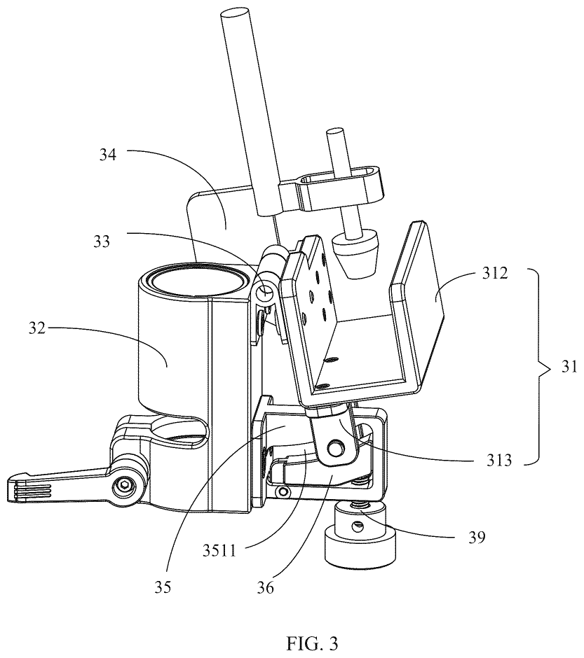

To facilitate horizontal adjustment during the initial stage of installing the installation crossbar 15, an included angle between the plane formed by the installation crossbar 15 and the two hanging rods 11 is adjustable in this embodiment. The present application does not limit the specific manner of achieving the adjustable angle. In one embodiment, a telescopic structure can be added between the lower end of the installation rod 9 and each hanging rod 11 to change the included angle by adjusting the length of the telescopic structure. In another embodiment, referring to FIG. 3, the hanging vehicle-mounted camera device 100 further includes two clamping structures 3 corresponding to the two hanging units 10. Each clamping structure 3 includes a bracket 31, a self-locking sleeve 32, and a hinge 33. An upper surface of the bracket 31 is provided with a first installation slot 311 that extends transversely. The first installation slot 311 is used for fixedly installing the installation crossbar 15. The self-locking sleeve 32 is sleeved on an outer surface of the hanging rod 11. The self-locking sleeve 32 has a movable state capable of sliding up and down, and a locked state relatively fixed to the hanging rod 11. The hinge 33 connects the bracket 31 and the self-locking sleeve 32, respectively, so that the bracket 31 can rotate relative to the self-locking sleeve 32. The bracket 31 has an overall U-shaped structure, and the size of the first installation slot 311 should be adapted to the size of the installation crossbar 15, with the two connected via screws. The hinge 33 itself has a rotating shaft, enabling rotation between the bracket 31 and the self-locking sleeve 32. Correspondingly, the installation crossbar 15 is integrally connected to the corresponding hanging rod 11 through two hinges 33. The self-locking sleeve 32 can slide up and down to move the installation crossbar 15 vertically.

Based on the above embodiment, to achieve fixation between the bracket 31 and the installation crossbar 15, please referring to FIG. 3, the upper surface of the installation crossbar 15 is provided with sliding grooves 152 extending in the transverse direction in one embodiment. The hanging vehicle-mounted camera device 100 further includes two clamping fixtures 34 corresponding to the two hanging units 10. A platform 222 of each clamping fixture 34 is fixed to the corresponding bracket 31. An indenter of each clamping fixture 34 can extend into the corresponding sliding groove 152, and the indenter and a handle of each clamping fixture 34 are connected by a spring. It can be understood that the clamping fixture 34 can be obtained through purchase, which can prevent the installation crossbar 15 from jumping. In order to further ensure the effect, a spring is added in this embodiment (not shown).

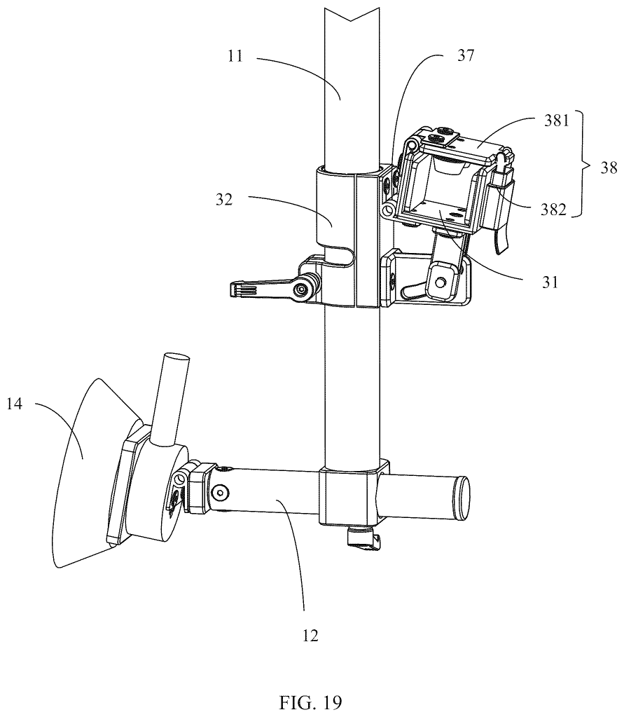

In another embodiment, referring to FIG. 19, the bracket 31 is fixedly installed with the installation crossbar 15 through a hinge structure 37 and a safety buckle 38. Specifically, the safety buckle 38 includes a connecting portion 381 and a buckle portion 382. The connecting portion 381 covers an upper opening of the bracket 31 and is pivotally connected to the bracket 31, so that the connecting portion 381 can be actively exposed to the first installation groove 311, or cover the first installation groove 311. The buckle portion 382 can be connected and fixed to the connecting portion 381 through a buckle ring. The buckle ring can be loosened, so that the connecting portion 381 remains in the position of covering the first installation groove 311, thereby pressing the installation crossbar 15. By adjusting a rope on the buckle portion 382, a tightening force can be adjusted, which has better stability and prevents the installation crossbar 15 from slipping.

To facilitate the fixation of the bracket 31 at a desired angle after adjustment, in one embodiment, referring to FIGS. 3 to 5, each of the clamping structures 3 further includes a fixed connection seat 35, a height adjustment block 36, and a first locking bolt 39. The fixed connection seat 35 is fixed to the outer surface of the self-locking sleeve 32. The bracket 31 is provided with a first installation slot 311 extending transversely on its transverse side. The fixed connection seat 35 is provided with a second installation slot 351. A top wall of the second installation slot 351 is arc-shaped, and a bottom of the second installation slot 351 is provided with a threaded hole 3512. The height adjustment block 36 is arranged in the second installation slot 351. An upper surface of the height adjustment block 36 is adapted to the top wall of the second installation slot 351 to define a sliding channel 3511 therebetween. One end of the height adjustment block 36 along the transverse direction is rotatably installed to the fixed connection seat 35 along a transversely extending axis, and the other end forms an inclined surface 361 inclined from bottom to top toward the end away from the height adjustment block 36. The first locking bolt is threadedly installed in the threaded hole 3512 and abuts against the inclined surface 361; the bracket 31 is connected to the hinge 33 at the upper end of the side surface, and the lower end is slidable along the sliding channel 3511. In use, by tightening or loosening the first locking bolt 39, the height adjustment block 36 can be driven to move upward or downward along the inclined surface 361, thereby changing the size of the sliding channel 3511. When the size of the sliding channel 3511 is large, a lower end of the bracket 31 can slide freely. When the size of the sliding channel 3511 is small, a portion of the bracket 31 extending into the inclined surface 361 is pressed tightly, thereby achieving angle fixation. The user only needs to operate the single first locking bolt 39, which is quick and convenient.

Furthermore, the present application does not limit the cooperation manner between the bracket 31 and the sliding channel 3511. In one embodiment, the lower end of the bracket 31 is directly made into a shape that can directly extend into the second installation slot 351. In this embodiment, the bracket 31 includes a bracket body 312 and two connection plates 313 arranged transversely and spaced apart from the lower end of the bracket body 312. The two connection plates 313 are respectively arranged on both sides of the fixed connection seat 35, and the first installation slot 311 is arranged on the bracket body 312; the clamping structure 3 also includes a connecting bolt, which can be screwed to the two connection plates 313 in turn. A part of the connecting bolt between the two connection plates 313 is located in the sliding channel 3511. The user can indirectly realize the connection between the bracket 31 and the fixed connection seat 35 through the connecting bolts. At the same time, the design of the two connection plates 313 can also play a good limiting role and improve stability. It can be understood that the swing angle of the bracket 31 is limited by the size of the second installation slot 351. When the connecting bolt is removed, the bracket 31 can swing freely. Moreover, although the hinge 33 itself does not involve angle limitation and can move freely, when the relative position of the bracket 31 and the fixed connection seat 35 is fixed, the hinge 33 cannot play a rotating role, and the angle will be fixed.

In addition, a spirit level vial can be set on the installation crossbar 15 to facilitate observation of the horizontal position of the installation crossbar 15 relative to the ground during angle adjustments.

In one embodiment, a gimbal 200 can be directly mounted on the sliding seat structure 22 for camera installation. The gimbal 200 includes a quick-release platform 222, two support plates, and a bowl bracket 201. The quick-release platform 222 is detachably installed to the sliding seat structure 22 through sliding-fit, facilitating quick installation and replacement of the camera. The lower ends of the two support rods 12 are fixed to the quick-release platform 222, and the upper ends jointly support the bowl bracket 201. It can be understood that when the two support rods 12 plates extend vertically, the projection of the bowl bracket 201 and the quick-release platform 222 on the plane coincide, and its center of gravity falls vertically on the sliding seat structure 22. In other embodiments, the gimbal 200 can be an eccentric gimbal 200, that is, the two support rods 12 plates are arranged obliquely. At this time, the projections of the bowl bracket 201 and the quick-release platform 222 on the plane are staggered, and the center of gravity will fall on the side of the sliding seat structure 22 facing away from the vehicle door. Users can choose a suitable gimbal 200 according to the actual usage conditions and the type of camera, which is not limited here.

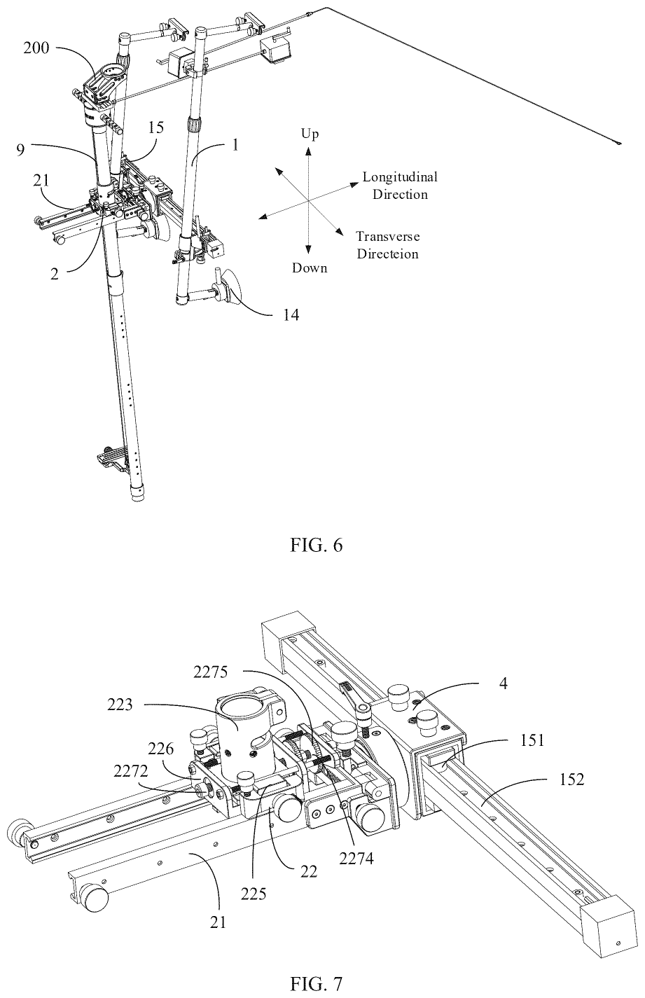

In another embodiment, referring to FIG. 6, the hanging vehicle-mounted camera device 100 further includes a length-adjustable installation rod 9. An upper end of the installation rod 9 is used for mounting a camera, and a lower end of the installation rod 9 is inserted into the ground. The installation rod 9 is installed through the sliding seat structure 22. The sliding seat structure 22 includes two movable blocks 221, a platform 222, and a fixing seat 223. The two movable blocks 221 are spaced apart transversely, and the two movable blocks 221 are slidably installed on the installation frame 21. The platform 222 is detachably installed on the two movable blocks 221. The middle of the platform 222 is provided with a through hole. The fixing seat 223 is arranged on the platform 222. The fixing seat 223 forms a through passage that is vertically through and communicates with the through hole, for the installation rod 9 to pass through and be installed. The fixing seat 223 has an unlocked state in which the installation rod 9 can slide vertically, and a locked state in which it is relatively fixed to the installation rod 9. In use, by adjusting the state of the fixing seat 223, the relative position of the installation rod 9 and the installation crossbar 15 can be adjusted. Moving the two movable blocks 221 can drive the installation rod 9 to adjust in the longitudinal direction. Moving the sliding seat 151 can drive the installation rod 9 to adjust in the transverse direction, thereby realizing multi-position adjustment of the camera. The camera is installed by means of the installation rod 9, and the ground is used for auxiliary support, which is convenient for ensuring the stability of the shooting picture when parking.

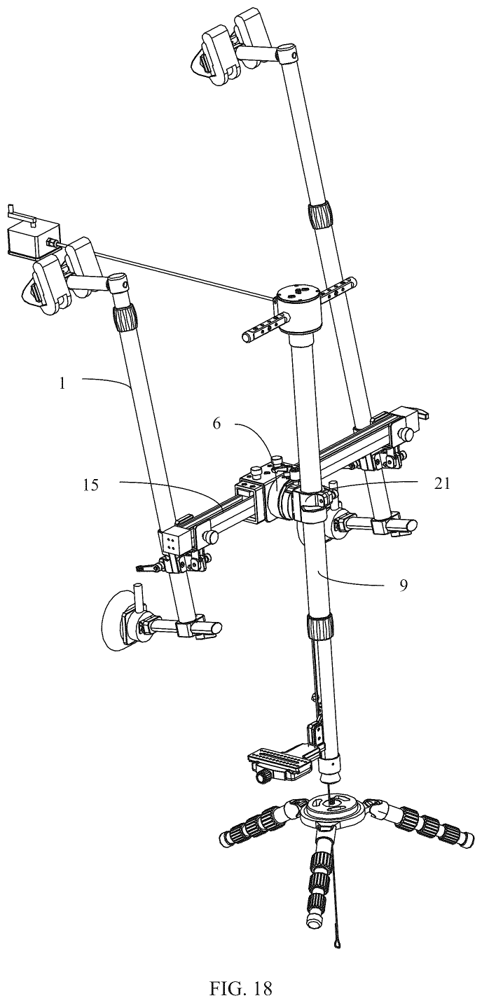

Referring to FIG. 18, the installation rod 9 can also be directly installed through the installation frame 21. At this time, the installation frame 21 is not designed as a bullhead frame or other structure with a certain sliding formation, but can be just a simple sleeve-like structure for the installation rod 9 to pass through. At this time, under the action of the first horizontal adjustment component 6, the installation rod 9 can be adjusted in angle, but the installation rod 9 cannot slide vertically or perform pitching movements. Its bottom can be supported by a tripod.

As shown in FIG. 18, the installation rod 9 can also be directly installed via the installation frame 21. In this case, the installation frame 21 is a simple cylindrical structure for the installation rod 9 to pass through. With the first leveling assembly 6, the installation rod 9 can be angled, but it cannot slide longitudinally or perform pitching motions. The bottom of the installation rod 9 can be supported by a tripod.

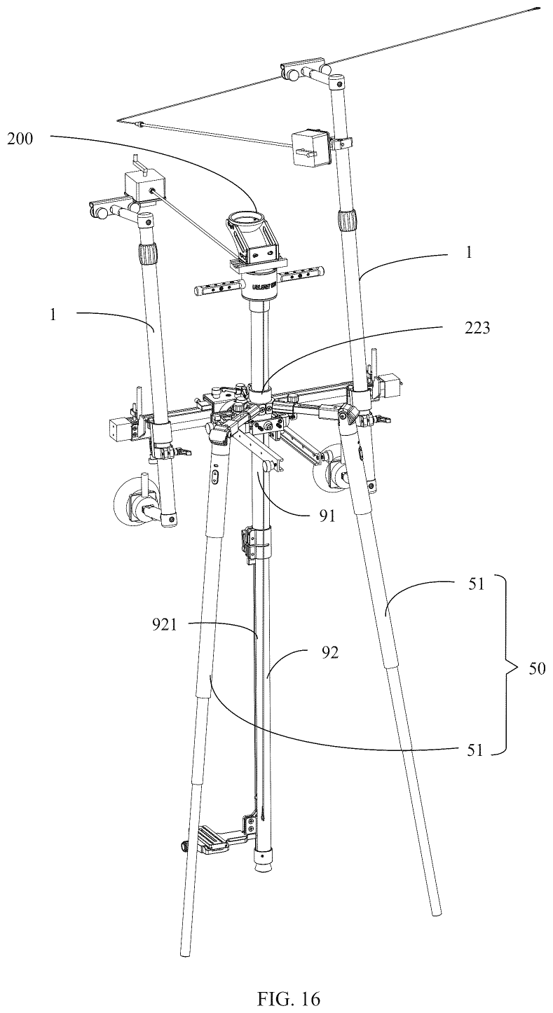

Video recording has become a popular trend, and video shooting demands high stability. Even slight shaking can lead to unsuccessful video shooting. Since photographers inside a vehicle cause it to shake, existing vehicle-mounted camera devices fail to meet the stability requirements for video shooting. Referring to FIG. 16, the hanging vehicle-mounted camera device 100 includes a support assembly 50 with multiple support sections 51. The upper ends of these support sections 51 are spaced around the installation rod 9 on the fixing seat 223. Lower ends of the support sections 51 are inserted into the ground. When used in vehicles, the support sections 51 and the installation rod 9 are jointly inserted into the ground for a stable multi-rod support. The installation rod 9, serving as the main support for the camera, allows height adjustment and pitching motions by changing its length and position relative to the sliding seat structure 22. The support sections 51, firmly inserted into the ground, provide stable support for the camera, ensuring shooting stability. Additionally, the ground-inserted support rods can be equipped with lifting devices for vertical camera adjustment to meet photographers' various requirements.

It should be noted that the present application does not limit the specific installation manner of the plurality of support sections 51. In one embodiment, the plurality of support sections 51 can be directly installed on an outer surface of the installation rod 9 through bearing connection. When a smooth rotation is needed, the plurality of support sections 51 of the rotating installation rod 9 can still remain fixed to the ground under the action of the bearing connection.

In other embodiments, the support assembly 50 further includes a connecting base plate, the connecting base plate is adapted to the outer surface of the fixing seat 223, and can be fixedly installed on the peripheral side of the fixing seat 223. Each of the support sections 51 includes a connecting rod and an electric telescopic rod. The connecting rod extends transversely, one end of the connecting rod is detachably installed to the side surface of the connecting base plate, the electric telescopic rod extends vertically and is adjustable in length, the upper end of the electric telescopic rod is connected to the other end of the connecting rod, and the angle between the connecting rod is adjustable, and the lower end of the electric telescopic rod is used for insertion into the ground. The connecting rod serves as a supporting joint, so that the overall distance of the electric telescopic rod from the installation rod 9 has a certain spacing to avoid interference with other structures. The electric telescopic rod can realize the change of its angle with the connecting rod bracket through rotating cooperation, arc hole screw cooperation, etc., that is, each of the electric telescopic rods can be adjusted to be inclined to be inserted into the ground. At this time, not only the platform 222 is more stable, but also the positions on the ground that are not easy to insert can be avoided. The design of the electric telescopic rod realizes the automatic telescopic adjustment of the length. When the user encounters uneven road surfaces, it can be easily telescoped to adapt to the ground and support the bottom. The user does not need to get off the vehicle to adjust, so as to avoid the trouble of getting off the vehicle to disturb wild animals, and the whole process can be operated in the vehicle. It can be understood that, in the process of adjusting the overall lifting and horizontal rotation of the installation rod 9 installation rod 9, the upper end of the electric telescopic rod can remain fixed together with the fixing seat 223, and the length can be self-adjusted through its own electric drive, so it can leave the ground.

Specifically, the present application does not limit the structural form of the electric telescopic rod, which can be set as a multi-section structure, with electric control of the relative position of adjacent two sections, enabling overall contraction and elongation. Specifically, it can be two sections, three sections, four sections, etc., which is not limited herein. Alternatively, the length can be adjusted by adding a folding hose and electrically controlling the compression and elongation of the folding hose.

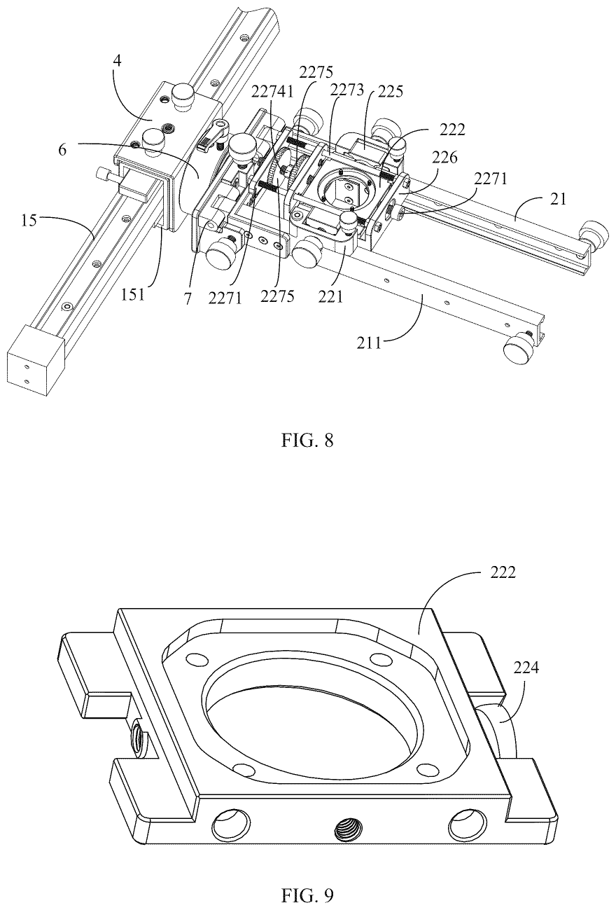

During use, because the bottom of the installation rod 9 remains fixed after being inserted into the ground, when the installation rod 9 is pitched, the trajectory of the installation rod 9 as it swings is a circular arc motion centered on the ground insertion point. At this time, the sliding of the installation rod 9 is subject to jamming and is not smooth enough, which affects the usability. Therefore, referring to FIGS. 8 to 10, the opposite sides of the two movable blocks 221 are recessed with accommodation grooves 2211 extending upwards. A lower wall surface of each accommodation groove 2211 is provided with two first slots 2211a spaced apart in the longitudinal direction. Walls of the two first slots 2211a facing away from each other are configured to pass through the corresponding movable block 221. The platform 222 has two mounting ends opposite each other in the transverse direction. The two mounting ends are respectively inserted and mounted in the two accommodation grooves 2211, and the platform 222 can be tilted relative to the movable block 221 under the action of external force, so that one end of each mounting end in the longitudinal direction can extend into the corresponding first slot 2211a. The platform 222 is used for mounting the installation rod 9 for installing the camera. Initially, the platform 222 can be in contact with the lower wall surface of the accommodation groove 2211, and the whole is horizontal, maintaining the stability of the platform 222. When forward tilting is required, the installation rod 9 is pushed. At this time, the platform 222 is tilted by external force, and the front end of each mounting end will extend into the corresponding first slot 2211a, and the rear end will be lifted up. At this time, the pitching action of the camera is based on the movable block 221, and will not affect the sliding of the movable block 221 itself. The position of the movable block 221 remains horizontal, and only the base plate 71 is tilted, so that the friction caused by the angular interference between the circular arc motion mode and the bullhead frame during pitching and rocking motion can be avoided, making the camera smooth when pitching and rocking by relying on the installation rod 9, and improving the user's experience.

Furthermore, a second slot 2211b is also provided between the two first slots 2211a, and a groove penetrating in the vertical direction is formed by recessing the middle of the opposite sides of the two mounting ends; the sliding seat structure 22 also includes two sliding bearings 224, which are rotatably installed in the two grooves along the axis extending in the transverse direction, and the lower end of each sliding bearing 224 is in contact with the second slot 2211b. The two sliding bearings 224 are high-speed miniature bearings, which can be used as fulcrums to roll in the second slot 2211b when the platform 222 is tilted, thereby reducing the friction and ensuring the stability of pitch.

Furthermore, in this embodiment, the sliding seat structure 22 also includes two bolts. The two bolts are respectively threaded through the opposite sides of the two movable blocks 221 to extend into the accommodation groove 2211, and are used to abut against the corresponding side of the platform 222. Thereby a connection between the platform 222 and the movable block 221 is provided, which can fix the relative position of the two.

In one embodiment, referring to FIG. 8 and FIG. 12, the sliding seat structure 22 further includes two locking blocks 225 and a plurality of elastic members. The two locking blocks 225 are respectively arranged between the two mounting ends and the sidewall of the corresponding accommodation groove 2211. Each locking block 225 has at least three engaging holes 2251 spaced apart in the longitudinal direction on the side facing away from each other. The engaging hole 2251 located in the middle is used for a bolt to pass through. The plurality of elastic members are respectively installed in the plurality of engaging holes 2251 located on the side, and the end of each elastic member abuts against the sidewall of the corresponding accommodation groove 2211. The locking block 225 is used to compensate for the fitting gap between the platform 222 and the accommodation groove 2211. The elastic member provides a pre-tightening force to ensure the position of the locking block 225 and the state of tight cooperation with the platform 222.

It should be noted that, in one embodiment, the elastic member is a pre-tightening spring, while in other embodiments, a rubber member may also be used, which is not limited here.

Furthermore, an annular relief groove is formed on the threaded section of each of the bolts, and a first threaded hole is opened on the upper wall surface of the middle mating groove 2251. The sliding seat structure 22 also includes two connecting screws, each of which is threadedly installed into the corresponding first threaded hole to extend into the corresponding annular relief groove. In a stable state, the bolt abuts against the platform 222, and the locking block 225 is subjected to the elastic force of the elastic member, maintaining a stable state, so that both sides of the platform 222 can be tensioned and balanced, ensuring stability. When the platform 222 needs to move, the bolt is loosened. At this time, the locking block 225 is restricted by the connecting screw, and thus can retract together under the drive of the bolt. At this time, the elastic member is compressed, the locking block 225 is separated from the platform 222, and the platform 222 can swing. Such a setting can also prevent the bolt from completely exiting the accommodation groove 2211 after loosening, avoiding the difficulty of aligning the parts for the user during reassembly.

To ensure that the locking block 225 does not pop up after installation, in this embodiment, referring to FIG. 12, the upper ends of the two sidewalls of each accommodation groove 2211 along the longitudinal direction are provided with baffles extending towards each other. The two sides of the locking block 225 along the longitudinal direction are protrudingly provided with first blocking blocks. The upper end surface of each blocking block abuts against the corresponding two baffles. At this time, the position of the locking block 225 is limited by the first blocking block, and it will not be upturned upwards under the action of elastic force. At the same time, it can maintain a relatively stable orientation with the movable block 221. It can be understood that the transverse movement stroke of the locking block 225 should not exceed the transverse dimension of the baffle.

Furthermore, when setting the sliding bearing 224, the upper ends of the opposing sides of the two locking blocks 225 are provided with second blocking blocks, and the second blocking blocks extend above the platform 222 and are capable of covering the arrangement of the sliding bearing 224, ensuring the overall appearance after assembly, while also protecting the sliding bearing 224.

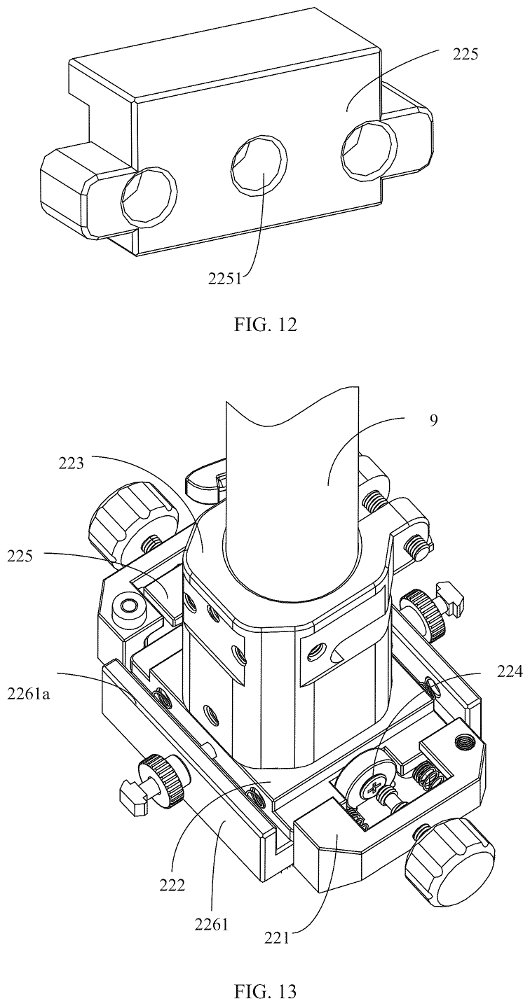

In order to fix the platform 222 in different orientations, referring to FIG. 8 and FIG. 11, the sliding seat structure 22 also includes an insert block assembly 226. The insert block assembly 226 includes two insertion structures and a connection structure. The two insertion structures are both located between the two installation beams 211 and are located on both longitudinal sides of the platform 222. Each insertion structure includes an insert block body 2261, a spring locating groove, and multiple springs. The insert block body 2261 includes a first plate body 2261a extending in the vertical direction and a second plate body 2261b extending towards the platform 222. The side of the second plate body 2261b facing the platform 222 forms an inclined surface 22611 that is inclined from top to bottom in a direction away from the platform 222. The insert block body 2261 can be movably inserted into the corresponding two first slots 2211a, such that the inclined surface 22611 contacts a lower wall surface of the first slot 2211a. Multiple spring locating grooves are respectively arranged on both transverse sides of the platform 222. Multiple springs are arranged between the first plate body 2261a and the platform 222 and are respectively inserted into the corresponding spring locating grooves. When the platform 222 is in a balanced state, the second plate body 2261b can be inserted into the first slot 2211a. At this time, each insert block body 2261 is maintained in a relative position with the platform 222 under the action of the connection structure and the spring force, so as to compensate for the gap between the base plate 71 and the bottom wall of the first slot 2211a, and to provide a stable support plane for the platform 222. The first plate body 2261a maintains a stable position under the joint action of the spring force and the connection structure, and is in a tensioned state. At this time, the inclined surface 22611 does not function. When adjusting the inclination of the platform 222, the connection structure is first adjusted to increase the distance between the insert block body 2261 and the platform 222, the spring is extended, and the second plate body 2261b is driven to leave the first slot 2211a. After the platform 222 is inclined, the length that the second plate body 2261b of each insert block body 2261 can extend is reasonably adjusted according to the remaining gap in the first slot 2211a. It can be understood that the lengths of the two second plate bodies 2261b extending on the longitudinal sides are different. At this time, since the insert block body 2261 is always connected to the platform 222 through the idle connection structure, it is inclined together with the platform 222. Therefore, the cross-section of the remaining gap in the first slot 2211a is also triangular. At this time, the inclined surface 22611 functions to fit the bottom wall surface of the first slot 2211a, thereby limiting the platform 222 and restricting it to a specific inclination angle. Thus, the platform 222 can be fixed in any state.

It should be noted that the present application does not limit the manner in which the relative positions of the two insert block bodies 2261 and the platform 222 are fixed. In one embodiment, referring to FIG. 13, the middle of each of the first plate bodies 2261a is provided with a second threaded hole extending in the longitudinal direction. The connecting structure includes two second locking bolts, each of which is threadedly inserted into the second threaded hole and can be inserted into the platform 222, wherein a plurality of spring positioning grooves are arranged on both sides of the second threaded hole in the transverse direction. The second locking bolt needs to always be inserted into the platform 222 to a certain depth, so that the second locking bolt can be tightened or loosened under different adjustment requirements, and the state of the spring will automatically change, so that the adjustment of the insert block body 2261 can be realized.

In another embodiment, referring to FIG. 7 and FIG. 8, two first plate bodies 2261a are provided with two first guiding through holes spaced apart in the transverse direction on the sides facing away from each other. The connecting structure includes a mating plate 2271, a connecting rod 2272, two guide rods 2273, and a locking threaded rod 2274. The mating plate 2271 is arranged on one side of the insert body 2261 away from the platform 222. The middle part of the mating plate 2271 is provided with an adjustment threaded hole, and second guiding through holes are respectively opened on both sides of the adjustment threaded hole along the transverse direction. The end of the connecting rod 2272 passes through the middle part of the first plate body 2261a on the side facing away from the mating plate 2271, and is threadedly installed on the platform 222. Each of the guide rods 2273 is movably inserted into the second guiding through hole and the corresponding first guiding through hole on each insert body 2261. Both ends of the locking threaded rod 2274 are threadedly installed on the mating plate 2271 and the platform 222, respectively. The middle part of the locking threaded rod 2274 can pass through the corresponding insert body 2261. The locking threaded rod 2274 is provided with a stop portion 22741 on the section between the mating plate 2271 and the corresponding insert body 2261. Adjustment nuts 2275 are sleeved between the stop plate and the mating plate 2271 and the corresponding insert body 2261. Both of the adjustment nuts 2275 are on the side close to the vehicle window, which is convenient for the user to directly operate. By setting the mating plate 2271 on the side facing the vehicle door, the user can reach out and only operate the two adjustment nuts 2275 to change the insertion depth of the two insert bodies 2261, thereby limiting the inclination angle of the platform 222. The operation steps are simpler. In this embodiment, the adjustment nut 2275 close to the vehicle window corresponds to adjusting the position of the insert body 2261 away from the vehicle window (the illustrated is the limit position of the adjustment nut 2275 towards the vehicle window). The adjustment nut 2275 away from the vehicle window corresponds to adjusting the position of the other insert body 2261 adjacent to it. The two guide rods 2273 play the role of connection and guidance. The connecting rod 2272 and the locking threaded rod 2274 simultaneously play the role of connecting the two insert bodies 2261 and the platform 222. It can be understood that adjusting the corresponding adjustment nut 2275 can make the corresponding insert body 2261 move relative to the two guide rods 2273 under the action of spring force. Each insert body 2261, the connecting rod 2272, and the locking threaded rod 2274 are all in clearance fit, so they are only subjected to blocking force and elastic force, and will not be tightened by threads. The compression of the springs on both sides in the longitudinal direction drives the two insert bodies 2261 to move simultaneously.

In this embodiment, multiple bolt threads can be passed through the periphery of the platform 222, and the inclination angle of the platform 222 can be adjusted by adjusting the height of each bolt. At the same time, the characteristics of thread cooperation can maintain the locking device, which will not be described in detail here.

In addition, the installation beam 211 and the movable block 221 are engaged through a chute and pulley rail structure, and a blocking bolt is arranged at the end of the installation beam 211 facing away from the dark crossbar, which can be threaded into the chute of the installation beam 211 to block the sliding seat structure 22 and the first movable seat 81.

Other cameras or auxiliary camera mounting structures can be connected to the installation crossbar 15, the upper end of the installation rod 9, and the hanging rod 11 by adding studs, gimbals 200, heavy-duty clamps, or other means, which are not limited herein.

It should be noted that, in the embodiments of the present application, with the bracket 31 as the foundation, the installation structure 2, the first leveling assembly 6, the second leveling assembly 7, the lifting assembly 80, and the support assembly 50 are all optional accessories. Users can choose to install some or all of them according to actual needs.

Specifically, the installation rod 9 includes a first sleeve 91 and a second sleeve 92 that are sequentially sleeved, the first sleeve 91 is mounted on the sliding seat structure 22, the second sleeve 92 is inserted from the lower end of the first sleeve 91, and is capable of being movably installed in the up and down direction, a long guide groove 921 extending in the up and down direction is formed on the peripheral side of the second sleeve 92, and the bottom wall of guide groove 921 is through-set. In addition, the installation rod 9 inserted into the ground can be equipped with a lifting device, and the shooting equipment can be lifted up and down on the installation rod 9 to adjust the shooting angle and meet the photographer's more requirements for vehicle shooting. Specifically, it also includes a connecting piece and a locking sleeve, one end of the connecting piece is slidably installed in the long guide groove 921 through a driving structure, and the other end is used to install a shooting camera. The locking sleeve is sleeved on the outer surface of the first sleeve 91, and corresponds to the overlapping part of the first sleeve 91 and the second sleeve 92, and can lock the first sleeve 91 and the second sleeve 92. The overlapping length of the first sleeve 91 and the second sleeve 92 can be changed by adjusting the tightness of the locking sleeve. At this time, the installation rod 9 realizes adjustable length through the cooperation of the first sleeve 91 and the second sleeve 92. At the same time, a connecting piece is added to allow the shooting camera to be installed, realizing a low shooting height.

In order to adjust the position of the connecting piece within the guide groove 921, the connecting piece can be driven by a hand crank and a drive rope as a driving structure. The hand crank is placed externally, with the handle control portion of the hand crank extending into the vehicle interior for the occupants to grip. The drive rope is located within the inner cavity of the second sleeve 92, with its upper end extending out of the second sleeve 92 and the first sleeve 91 to connect to the winding drum of the hand crank, and its lower end connected to the connecting piece to drive the connector to move back and forth in the vertical direction. By rotating the handle of the hand crank, the drive rope is driven to wind or extend, so that the lower end of the drive rope moves vertically, thereby driving the connecting piece to move vertically, and thus driving the camera to rise and lower relative to the installation rod 9, making it more convenient for photographers to operate inside the vehicle.

It can be understood that the number of hand cranks can be increased according to actual needs and the number of cameras available on the device, so that the external camera shooting or position adjustment can be directly controlled from inside the vehicle.

In summary, in the technical solution of the present application, the deflector groove and the outer surface of the vehicle door are used for positioning, and the whole hanging vehicle-mounted camera device is hung on the outside of the vehicle door, offering robust load-bearing capacity and stability. It operates independently of the vehicle window, allowing the vehicle window to remain closed and enhancing safety. The camera installation offers horizontal and vertical adjustments for flexibility. Users can capture subjects on both sides of the vehicle door with a slight body turn. The device also includes vertically movable components with one or more ground-inserted, telescopic support sections 51 for stable support. The ground-inserted installation rod 9 can be equipped with a lifting device for vertical camera adjustment to meet various shooting requirements.

It has no cooperative relationship with the window, and does not affect the closing of the window. It has better safety performance. The shooting camera has horizontal and vertical position adjustment, which is more flexible. By rotating the shooting camera, the user can slightly turn the body to shoot the subject on both sides of the vehicle door. At the same time, one or more support sections 51 are installed on the vertically moving frame, i.e. the sliding seat structure 22, and inserted into the ground. Inserting into the ground is the most stable support method. The stable support of the shooting equipment ensures the stability during the shooting process. At the same time, the ground-inserted installation rod 9 can be equipped with a lifting device for vertical camera adjustment to meet various shooting requirements.

The above descriptions represent only some embodiments of the present application and shall not be construed as limiting the patent scope of the present application. Where equivalent structural transformations are made using the description and drawings of the present application under its inventive concept, or where the application is directly or indirectly applied to other related technical fields, all such implementations shall fall within the scope of patent protection of the present application.

The foregoing descriptions are merely some embodiments of the present application, and do not thereby limit the patent scope of the present application. All equivalent structural transformations made under the concept of the present application, utilizing the description and drawings of the present application, or direct/indirect applications in other related technical fields are included within the scope of the present application.

1. A hanging vehicle-mounted camera device, comprising:
a support structure, including two hanging units and an installation crossbar, wherein the two hanging units are spaced apart in a transverse direction, each hanging unit comprising a hanging rod and two support rods detachably installed at upper and lower ends of the hanging rod, the hanging rod extends in a vertical direction with an adjustable length, the two support rods extend in a longitudinal direction, the upper support rod is adapted to cooperate with a deflector groove on an upper side of a vehicle door, the lower support rod is adapted to cooperate with an outer surface of the vehicle door, the installation crossbar is located on the side of the two hanging units facing the vehicle door, and a sliding seat is mounted on the installation crossbar for sliding movement in the transverse direction; and
an installation structure, including an installation frame for mounting a camera, one end of the installation frame in the longitudinal direction is detachably mounted on the sliding seat.

2. The hanging vehicle-mounted camera device according to claim 1, further comprising a connecting hanger, the upper end of which is bent to define a hanging slot, wherein the hanging slot can cooperate with the outer surface of the sliding seat, and the connecting hanger is fixed to the sliding seat with a screw;
and the installation frame can be connected to a side face of the connecting hanger.

3. The hanging vehicle-mounted camera device according to claim 2, wherein a first leveling assembly is provided between the installation frame and the connecting hanger, so as to allow the installation frame to rotate relative to the connecting hanger for horizontal adjustment in the transverse direction.

4. The hanging vehicle-mounted camera device according to claim 3, wherein the first leveling assembly comprises:
a seat body, fixedly mounted on the side of the installation frame facing the connecting hanger;
a connecting sleeve, fixedly mounted on the corresponding side face of the connecting hanger, and fitted over the outer surface of the seat body;
a bearing, an inner ring thereof is fitted over an outer surface of the seat body, and an outer ring thereof is fixedly mounted in an inner hole of the connecting sleeve, thereby enabling relative rotation between the seat body and the connecting sleeve; and
a locking structure, keeping the seat body and the connecting sleeve fixed.

5. The hanging vehicle-mounted camera device according to claim 4, wherein a second leveling assembly is provided between the seat body and the installation frame, and the second leveling assembly comprises:
a base plate, fixedly mounted on the side of the seat body opposite to the connecting hanger; and
a wedge-shaped adjusting block, mounted on the base plate for movement in the vertical direction and has an abutting inclined surface extending from top to bottom towards the installation frame;
wherein one end of the installation frame facing the connecting hanger is pivotally mounted on the base plate around a transverse axis, so that the other end of the installation frame can swing in the vertical direction, and the abutting inclined surface always abuts against a front lower side of the installation frame during the movement of the adjusting block, thereby adjusting an included angle between the installation frame and the base plate.

6. The hanging vehicle-mounted camera device according to claim 1, wherein the installation structure comprises a sliding seat structure, which is slidably mounted on the installation frame in the longitudinal direction and is used for installing a camera.

7. The hanging vehicle-mounted camera device according to claim 6, wherein the installation structure further comprises a lifting assembly, which comprises:
a first movable seat, slidably mounted on the installation frame in the longitudinal direction and spaced apart from the sliding seat structure in the longitudinal direction;
a telescopic rod, extending in the vertical direction, comprising a first tube and a second tube fitted over each other, the first tube and the second tube being movable relative to each other, the upper end of the second tube being connected to the first movable seat, and the lower end of the first tube being insertable into the ground;
a hand-cranked reeling mechanism, comprising a hand-cranked reel and a connecting wire, one end of the connecting wire being connected to the first tube, and the other end being fixed on the hand-cranked reel, so as to lift the first tube when the connecting wire is reeled in; and
a locking member, locking the first tube and the second tube in a fixed position.

8. The hanging vehicle-mounted camera device according to claim 6, comprising a length-adjustable installation rod, an upper end of the installation rod being used for installing a camera, and a lower end of the installation rod being insertable into the ground, the installation rod being installed via the sliding seat structure, which comprises:
two movable blocks, spaced apart in the transverse direction and slidably mounted on the installation frame;
a base plate, detachably mounted on the two movable blocks, the base plate having a central through-hole; and
a fixing seat, provided on the base plate, the fixing seat having a through passage extending vertically and communicating with the through-hole, for the installation rod to pass through, the fixing seat having an unlocked state in which the installation rod can slide vertically and a locked state in which it is fixed relative to the installation rod.

9. The hanging vehicle-mounted camera device according to claim 1, wherein an included angle between the installation crossbar and the plane formed by the two hanging rods is adjustable.

10. The hanging vehicle-mounted camera device according to claim 8, comprising a supporting assembly, which comprises a plurality of supporting sections, upper ends of the supporting sections being spaced apart around the installation rod on the fixing seat, and lower ends of the supporting sections being insertable into the ground.

11. The hanging vehicle-mounted camera device according to claim 8, wherein the two movable blocks each define an upward-through accommodation groove on opposing side surfaces, a lower wall of each accommodation groove having two first slots spaced longitudinally apart, walls of the two first slots facing away from each other are configured to pass through the corresponding movable block;
the base plate has two transversely opposing mounting ends, each inserted into the respective accommodation groove, and the base plate can be inclined relative to the movable blocks under external force, so that each mounting end can extend into the corresponding first slot, and the base plate is used for installing the installation rod mounted with a camera.

12. The hanging vehicle-mounted camera device according to claim 1, wherein the upper support rod cooperates with the deflector groove on an upper side of the vehicle door via a first connecting unit, each first connecting unit including a clip and a bolted rod, an upper end of the clip is bent away from the hanging rod to form a downward-opening clip groove for engagement with the deflector groove, one end of the bolted rod is connected to a longitudinal side of the clip, and the other end is threadedly mounted to the corresponding support rod.

13. The hanging vehicle-mounted camera device according to claim 1, wherein the upper support rod cooperates with the deflector groove on an upper side of the vehicle door via a first connecting unit, each first connecting unit including a abutting member and at least one strap structure, the abutting member contacts the vehicle door surface, the strap is fixed to the vehicle door frame, and the abutting member is pressed against the vehicle door.

14. The hanging vehicle-mounted camera device according to claim 1, wherein the lower support rod cooperates with a surface of the vehicle door via a second connecting unit, each second connecting unit including a suction cup connected to the corresponding support rod via a hinge.

15. The hanging vehicle-mounted camera device according to claim 1, comprising two clamping structures corresponding to the two hanging units, each clamping structure includes a bracket, a self-locking sleeve, and a hinge, wherein an upper surface of the bracket defines a first installation slot running through transversely for fixing the installation crossbar, the self-locking sleeve accommodates the hanging rod, the hinge connects the bracket and the self-locking sleeve, and the bracket is fixed to the installation crossbar either by a clamping fixture or via a hinge structure combined with a safety catch.

16. A hanging vehicle-mounted camera device, comprising:
a support structure, including two hanging units and an installation crossbar;
an installation structure, including an installation frame for mounting a camera; and
two clamping structures, corresponding to the two hanging units;
wherein the two hanging units are spaced apart in a transverse direction, each hanging unit is height-adjustable in a vertical direction; an upper end and a lower end of each hanging unit are respectively configured to cooperate with a deflector groove and an outer surface of a vehicle door; the installation crossbar is located between the two hanging units in the transverse direction, the two hanging units are connected to opposite ends of installation crossbar by the two clamping structures; the installation frame is slidably mounted on the installation crossbar in the transverse direction, and a position of the camera on the installation frame is adjustable in a longitudinal direction.

17. The hanging vehicle-mounted camera device according to claim 16, wherein each hanging unit comprises a hanging rod and two support rods, the hanging rod extends in the vertical direction with an adjustable length; the two support rods extend in the longitudinal direction, and are respectively installed at upper and lower ends of the hanging rod.

18. The hanging vehicle-mounted camera device according to claim 16, wherein each of the upper support rods is coupled with the deflector groove of the vehicle door via a first connection unit;
each of the first connection units includes a clip and a bolted rod, the clip is bent to form a downward-facing clip groove, which is used for snap-fit engagement with the deflector groove;
one end of the bolted rod connects the clip, and the other end is threadedly installed to the corresponding support rod.

19. The hanging vehicle-mounted camera device according to claim 16, wherein each of the lower support rods interfaces with the outer surface of the vehicle door via a second connecting units, and each second connecting unit includes a suction cup 141, which is used for adhesively fixing to the outer surface.

20. The hanging vehicle-mounted camera device according to claim 16, wherein the installation structure comprises:
a sliding seat structure, slidably mounted on the installation frame in the longitudinal direction and used for installing a camera; and
a lifting assembly, comprising:
a first movable seat, slidably mounted on the installation frame in the longitudinal direction;
a telescopic rod, extending in the vertical direction, comprising a first tube and a second tube fitted over each other, the first tube and the second tube being movable relative to each other, the upper end of the second tube being connected to the first movable seat, and the lower end of the first tube being insertable into the ground;
a hand-cranked reeling mechanism, including a hand-cranked reel and a connecting wire, one end of the connecting wire being connected to the first tube, and the other end being fixed on the hand-cranked reel, so as to lift the first tube when the connecting wire is reeled in; and
a locking member, locking the first tube and the second tube in a fixed position.
